(19) United States
(12) Patent Application Publication
(10) Pub. No.: US 2021/0111402 A1
(43) Pub. Date: Apr. 15, 2021

(54) LITHIUM ION BATTERY INCLUDING CATHODE ACTIVE MATERIAL AND ELECTRONIC DEVICE INCLUDING SAME

(71) Applicant: Samsung Electronics Co., Ltd., Suwon-si (KR)

(72) Inventors: Bookeun Oh, Suwon-si (KR); Sungun Wi, Suwon-si (KR); Jaeyeon Lee, Suwon-si (KR)

(21) Appl. No.: 17/065,929

(22) Filed: Oct. 8, 2020

(30) Foreign Application Priority Data
Oct. 10, 2019 (KR) 10-2019-0125301

(51) Int. Cl. H01M 4/505; H01M 4/525; H01M 4/583; H01M 4/66; H01M 2/14; H01M 10/0525

(52) U.S. Cl. CPC H01M 4/505; H01M 4/525; H01M 10/0525; H01M 4/662; H01M 2/14; H01M 4/583

(57) ABSTRACT

A lithium ion battery is provided. The lithium ion battery includes a cathode, an anode, an electrolyte, and a separator interposed between the cathode and the anode, wherein the cathode includes, as active materials, a first LiCoO₂ (LCO), a second LCO, and LiCoₓMn_{y}Fe_{z}PO₄ having a coating layer on the surface thereof, the first LCO has a first size, the second LCO has a second size smaller than the first size such that the second LCO is arranged in the cavities formed by the first LCO, and the LiCoₓMn_{y}Fe_{z}PO₄ has a third size smaller than both the first size and the second size such that the LiCoₓMn_{y}Fe_{z}PO₄ is arranged in the cavities formed by at least one of the first LCO and the second LCO, and the LiCoₓMn_{y}Fe_{z}PO₄ has the composition ratio of x+y+z=1 (with a proviso of 0.5≤y≤1).

### CROSS-REFERENCE TO RELATED APPLICATION(S)

This application is based on and claims priority under 35 U.S.C. § 119(a) of a Korean patent application number 10-2019-0125301, filed on Oct. 10, 2019, in the Korean Intellectual Property Office, the disclosure of which is incorporated by reference herein in its entirety.

### BACKGROUND

### 1. Field

The disclosure relates to a lithium ion battery including a cathode active material and an electronic device including the same.

### 2. Description of Related Art

FIG. 1 is a schematic view of a first cathode active material according to the related art.

Reference may be made to a first cathode active material 100 depicted in FIG. 1 as a related art contrasting to various embodiments of the disclosure.

Referring to FIG. 1, the first cathode active material 100 may include LiCoO₂ (hereinafter referred to as “LCO”) particles different in size, for example, first LCO 110 and second LCO 120. The second LCO 120 particles relatively small in size fill spaces among the first LCO 110 particles relatively large in size, whereby the first cathode active material 100 can improve in energy density per volume.

If composed only of the first LCO 110 and/or the second LCO 120, the first cathode active material 100 may elute cobalt (Co) or generate oxygen during the intercalation or deintercalation of lithium ions (Li+). The first cathode active material 100 may undergo phase transition between hexagonal and monoclinic phases according to the extent of intercalation or deintercalation of lithium ions, resulting in a structural collapse. By way of example, a lithium ion battery can maintain a hexagonal structure in a reversible manner even though lithium ions escape to up to a certain limit within the theoretical capacity of the battery. In contrast, an escape of lithium ions exceeding the certain limit may make the structure unstable, incurring irreversible phase transition to the monoclinic structure. The first cathode active material 100 makes it difficult to increase the upper limit voltage to more than 4.2 V in order to achieve a high-capacity lithium ion battery and can utilize about half of the theoretical capacity (274 mAh/g).

With the performance enhancement and miniaturization of electronic devices, such as mobile devices, etc., there has been an increase in demand for lithium ion batteries characterized by high capacity, quick charging, and high output.

However, the above phenomenon of the first cathode active material 100 may degrade in a quick charging condition. Upon quick charging, lithium ions within the first cathode active material 100 are deintercalated at higher speeds to migrate to an anode material through an electrolyte than in a normal charging condition. In this regard, the LCO particles have a smaller concentration of lithium ions at the surfaces than in the inside thereof. The concentration gradient between the surface and the inside may cause a decrease in the chemical or structural stability of the LCO particle surfaces, worsening lifetime properties of the first cathode active material 100.

In an embodiment, the first cathode active material 100 may include surface-coated LCO particles in order to enhance surface stability of the LCO particles, but the surface coatings on the LCO particles may increase the internal resistance of the lithium ion battery. Lithium ion batteries with large internal resistance may not be suitable for use in a low-temperature condition such as winter or in a quick charging or a rapid discharging condition (for example, 5G communication condition requiring instantaneously high output).

In addition, a lithium ion battery may undergo the formation of an internal short circuit during the operation thereof under the following conditions: metal dendrite is deposited; copper included in the anode material is oxidized and eluted; a defect is generated in the separator, the solid electrolyte interphase (SEI) is degraded; or a physical impact is applied to the lithium ion battery. When formed, an internal short circuit increases the temperature of the lithium ion battery such that the electrolyte may be reacted with oxygen, resulting in a fire and explosion of the lithium ion battery.

The above information is presented as background information only to assist with an understanding of the disclosure. No determination has been made, and no assertion is made, as to whether any of the above might be applicable as prior art with regard to the disclosure.

### SUMMARY

A lithium ion battery employing LiCoO₂ (LCO) as a cathode active material may suffer from a structural problem such as an irreversible phase transition phenomenon upon quick charging and meet with a chemical side effect such as cobalt (Co) elution or oxygen release. Such structural and chemical problems may eat away at the safety and lifetime of the lithium ion battery.

Even though employing LCO substituted with a heterogeneous metal or coated with a metal oxide, the battery may increase in internal resistance. As a result, the increased internal resistance in the battery may degrade the performance of the lithium ion battery upon quick charging.

Aspect of the disclosure are to address at least the above-mentioned problems and/or disadvantages and to provide at least the advantages described below. Accordingly, an aspect of the disclosure is to provide lithium ion batteries can secure high energy density, quick charge and high output properties, and high safety and long lifetime properties.

Additional aspects will be set forth in part in the description which follows and, in part, will be apparent from the description, or may be learned by practice of the presented embodiments.

In accordance with an aspect of the disclosure, a lithium ion battery is provided. The lithium ion battery includes a cathode, an anode, an electrolyte, and a separator interposed between the cathode and the anode, wherein the cathode includes, as active materials, a first LiCoO₂ (LCO), a second LCO, and LiCoₓMn_{y}Fe_{z}PO₄ having a coating layer on the surface thereof, the first LCO has a first size, the second LCO has a second size smaller than the first size such that the second LCO is arranged in the cavities formed by the first LCO, and the LiCoₓMn_{y}Fe_{z}PO₄ has a third size smaller than both the first size and the second size such that the LiCoₓMn_{y}Fe_{z}PO₄ is arranged in the cavities formed by at least one of the first LCO and the second LCO, and the LiCoₓMn_{y}Fe_{z}PO₄ has the composition ratio of x+y+z=1 (with a proviso of 0.5≤y≤1).

In accordance with another aspect of the disclosure, an electronic device is provided. The electronic device includes a power management module, and a lithium ion battery configured to supply a necessary power to the electronic device by the power management module, the lithium ion battery including a cathode, an anode, an electrolyte, and a separator interposed between the cathode and the anode, wherein the cathode includes, as active materials, a first LiCoO₂ (LCO), a second LCO, and LiCoₓMn_{y}Fe_{z}PO₄ having a coating layer on the surface thereof, the first LCO has a first size, the second LCO has a second size smaller than the first size such that the second LCO is arranged in the cavities formed by the first LCO, and the LiCoₓMn_{y}Fe_{z}PO₄ has a third size smaller than both the first size and the second size such that the LiCoₓMn_{y}Fe_{z}PO₄ is arranged in the cavities formed by at least one of the first LCO and the second LCO, and the LiCoₓMn_{y}Fe_{z}PO₄ has the composition ratio of x+y+z=1 (with a proviso of 0.5≤y≤1).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of a first cathode active material according to the related art;

FIG. 2 is a schematic view of a secondary cathode active material according to an embodiment of the disclosure;

FIG. 3 is a schematic view showing a structure of LiCoO₂ (LCO) according to an embodiment of the disclosure;

FIG. 4 is a schematic view showing a structure of lithium metal phosphate (LiMnPO₄, LMP) according to an embodiment of the disclosure;

FIG. 5 is a graph showing discharge profiles of a second cathode active material and a first cathode active material according to an embodiment of the disclosure;

FIG. 6 is a graph showing discharge profiles of a second cathode active material and a first cathode active material in a battery having a degraded lifetime according to an embodiment of the disclosure;

FIG. 7 is a graph showing discharge profiles of a second cathode active material and a first cathode active material in a low-temperature condition according to an embodiment of the disclosure;

FIG. 8 is a graph showing volume ratios by size of particles contained in a second cathode active material according to an embodiment of the disclosure;

FIG. 9 is a flowchart showing a method for manufacturing LMP having an olivine structure according to an embodiment of the disclosure; and

FIG. 10 is a block diagram illustrating an electronic device in a network environment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to various embodiments, a lithium ion battery used in an electronic device may include a cathode material, an anode material, an electrolyte, and a separator.

The cathode material may include a cathode active material, and a current collector. The cathode active material may employ lithium oxide having a layered structure, especially, LiCoO₂ (LCO) as a material directly involved in electrode reactions of the lithium ion battery. The current collector for a cathode may be connected with an external circuit and used to supply the electrons generated during charging or discharging to the inside or outside of the cathode material. For the current collector, aluminum foil may be used mainly.

The anode material may include an anode active material and a current collector. The anode active material can store lithium atoms and graphite may be employed as a material for the anode active material. The current collector for an anode may be connected with an external circuit and used to supply the electrodes generated during charging or discharging to the inside or outside of the anode material. For the current collector, copper foil may be used.

The cathode active material and the anode active material may each be mixed with a conductive material and a binder. The conductive material may be added in order to improve ion conductivity and electron conductivity. The binder serves to facilitate the attachment of the active material (or electrode material) to the current collector and may be made of a polymer material such as polyvinylidene fluoride (PVDF).

Functioning to keep the cathode material and the anode material physically apart from each other, the separator may enhance safety of the battery.

The electrolyte may provide a path through which lithium ions pass and may be injected into the battery so as to permeate the separator and electrodes. The electrolyte may include a liquid electrolyte or a solid electrolyte.

In the lithium ion battery, lithium ions are deintercalated from the cathode active material and move to the anode active material through the electrolyte during charging. The lithium ions reaching the anode active material may undergo a reduction reaction and be intercalated into the anode active material. The electrons generated in the deintercalation process of lithium ions may move to the anode active material through an external circuit of the battery. Resulting from a non-spontaneous reaction, the behavior of the lithium ions at the cathode active material can be implemented only when an artificial potential difference is externally applied.

In the lithium ion battery, the lithium intercalated into the anode active material is deintercalated as ions into the electrolyte and the lithium ions move to the cathode active material through the electrolyte when discharging. The electrons generated in the deintercalation process of lithium ions may move to the cathode active material through the external circuit. The lithium ions recombine with the electrons in a reduction reaction and may be intercalated into the cathode active material. The lithium ions that pass through the external circuit can work because the behavior of the lithium ions at the anode active material results from a spontaneous reaction.

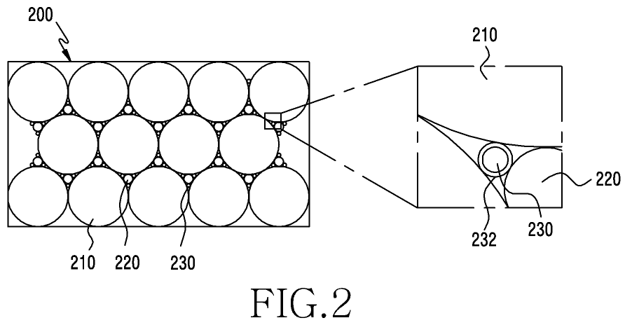

FIG. 2 is a schematic view of a secondary cathode active material according to an embodiment of the disclosure.

Referring to FIG. 2, a second cathode active material 200 may include a first LCO 210, a second LCO 220, and a lithium metal phosphate (LMP) 230.

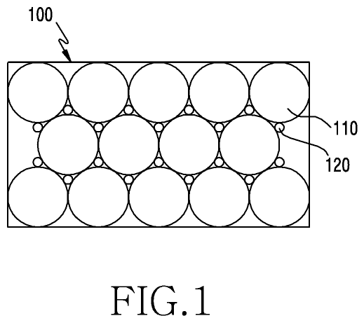

In an embodiment, the chemical properties of the first LCO 210 and the second LCO 220 may correspond to those of the first LCO 110 and the second LCO 120 described in FIG. 1, respectively.

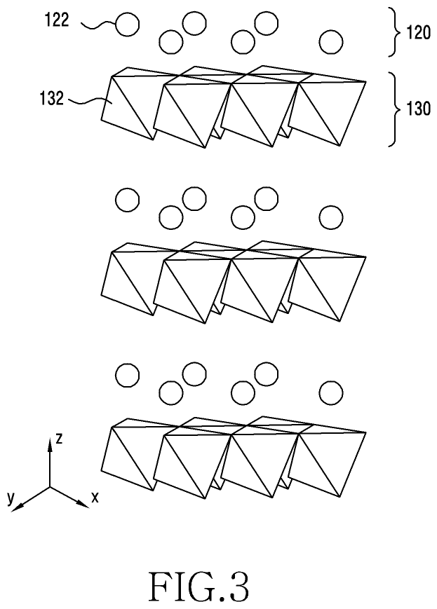

According to an embodiment, the first LCO 210 and the second LCO 220 may have a layered structure. Concrete features of the layered structure will be described later in conjugation with FIG. 3.

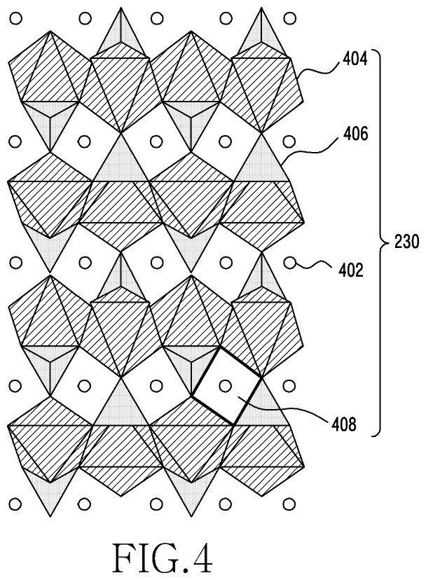

In an embodiment, the LMP 230 may have an olivine structure. Features of the olivine structure will be described later in conjugation with FIG. 4.

According to an embodiment, the LMP 230 may include the compound of Chemical Formula 1, below.

LiCoₓMn_{y}Fe_{z}PO₄ Chemical Formula 1

wherein x+y+z=1 (with the proviso of 0.5≤y≤1).

In an embodiment, the composition of chemical formula 1 may be preferably designed according to properties of a lithium ion battery required by an electronic device.

In an embodiment, as Fe increases in the relative content (z), the reaction rate of lithium ions increases to improve the output property of the lithium ion battery, but results in a reduction in the operating voltage and capacity of the lithium ion battery. In an embodiment, the lithium ion battery may increase in operating voltage and energy (capacity) with the increase of Mn in the relative content (y).

In an embodiment, the second cathode active material 200 including the LMP 230 may improve the lifetime of the battery. For example, when the battery has a degraded lifetime, the second cathode active material 200 may be higher than the first cathode active material 100 in terms of the operating voltage and available capacity of the battery under the same condition. According to an embodiment, the improvement in lifetime of the battery containing LMP 230 is attributed to the intrinsic properties of the LMP 230 material per se.

In an embodiment, the second cathode active material 200 including the LMP 230 may further enhance the performance of the battery, compared to the first cathode active material 100, in low-temperature conditions. In a low-temperature condition, for example, at about −20° C. to −10° C., the second cathode active material 200 may further increase the operating voltage and available capacity of the battery, compared to the first cathode active material 100. According to an embodiment, the improvement in lifetime of the battery containing LMP 230 is attributed to the intrinsic properties of the LMP 230 material per se.

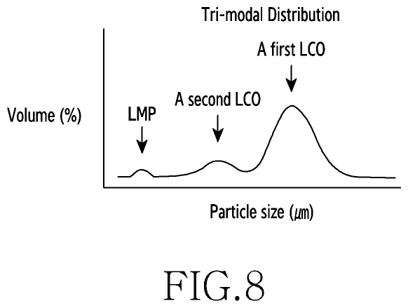

In an embodiment, the second cathode active material 200 may be achieved in a tri-modal pattern including the first LCO 210, the second LCO 220, and the LMP 230, which are different from one another in terms of size or particle diameter. Volume distributions of the first LCO 210, the second LCO 220, and the LMP 230 according to sizes will be explained later with reference to FIG. 8.

In an embodiment, the LMP 230 may include a coating layer 232. The LMP 230, which retains the property of an electrical nonconductor, may be coated with a material of electrically high conductivity, for example, carbon, in order to provide electron conductivity and ion conductivity. The coating layer 232 may be formed to have a thickness of 0.5 nm to 10 nm. The carbon-coated LMP 230 can make an electrical connection between the first LCO 210 and the second LCO 220 therethrough.

In an embodiment, even though the lithium ion battery increases in internal resistance with the surface treatment of the first LCO 210 and/or the second LCO 220, the electrical connection between the first LCO 210 and the second LCO 220 may improve the high output characteristic of the second cathode active material 200.

In an embodiment, lithium ions may be more quickly intercalated into LMP 230 than the first LCO 210 and the second LCO 220 because the LMP 230 is smaller in size than the first LCO 210 and the second LCO 220 and is coated with carbon. Given the second cathode active material 200 including the LMP 230, the lithium ion battery exhibits a reduced amount of heat even when a short circuit is formed inside or outside the lithium ion battery. The second cathode active material 200 including the LMP 230 can prevent a sharp increase of the temperature in the lithium ion battery even when a short circuit is formed.

In an embodiment, when rolled into an electrode, a mixture of the first LCO 210, the second LCO 220, and the LMP 230, which are different from one another in particle diameter, allows for a higher packing density. Furthermore, the LMP 230 functions as an active material and as such, can make a contribution to an improvement in the energy density of the second cathode active material 200.

FIG. 3 is a schematic view showing the structure of LiCoO₂ (LCO) according to an embodiment of the disclosure.

Referring to FIG. 3, the LCO (e.g., the first LCO 210 and the second LCO 220 in FIG. 2) may have a layered structure.

In an embodiment, the LCO may have a structure in which a lithium ion layer 120 composed of lithium ions 122 and a CoO₂ layer 130 are deposited in an alternating manner. The CoO₂ layer 130 is composed of a plurality of octahedral structures (or octahedrons) 132 in each of which the positively charged Co ion occupies the center point while the negatively charged oxygen ions (O²⁻) are located at the vertexes. The multiple octahedrons may share edges with each other to form one layer.

In an embodiment, the layered structure of LCO may establish a two-dimensional diffusion path for lithium ions of the LCO. Within the layered structure, for example, the lithium ions may have a low diffusion rate in the Z direction, but high diffusion rates in the x and the y direction.

FIG. 4 is a schematic view showing the structure of LiMnPO₄ (LMP) according to an embodiment of the disclosure.

Referring to FIG. 4, LMP 230 may have an olivine structure.

In an embodiment, the LMP 230 having an olivine structure may include lithium ions (402), MnO₆ octahedrons 404, PO₄ tetrahedrons 406, and LiO₆ octahedrons 408.

Lithium ions 402 and manganese (Mn) ions may occupy half of the sites of octahedrons 404 and phosphorus (P) ions may be arranged at ⅛′ of the sites of tetrahedron 406. The MnO₆ octahedrons 404 may be alternatingly arranged in a crossing pattern while sharing edges with each other. Each MnO₆ octahedron 404 may share one edge with the PO₄ tetrahedron 406 and two edges with the LiO₆ octahedron 408. In FIG. 4, the LiO₆ octahedrons 408 share an edge with each other and may be linearly arranged between the MnO₆ octahedrons 404.

In an embodiment, the aforementioned structural feature may make the diffusion of lithium ions very fast in the linear direction of the olivine structure compound, but cause the lithium ions to stagnate for the intercalation behavior thereof.

In an embodiment, the olivine structure compound which has a one-dimensional diffusion path for lithium ions may be lower in the diffusion rate of lithium ions than other substances having a spinel structure (three-dimensional) or a layered structure (two-dimensional).

In an embodiment, even when lithium ions 402 are deintercalated, LMP 230 can be structurally stabilized, unlike LCO, due to the structural feature of the olivine structure compound.

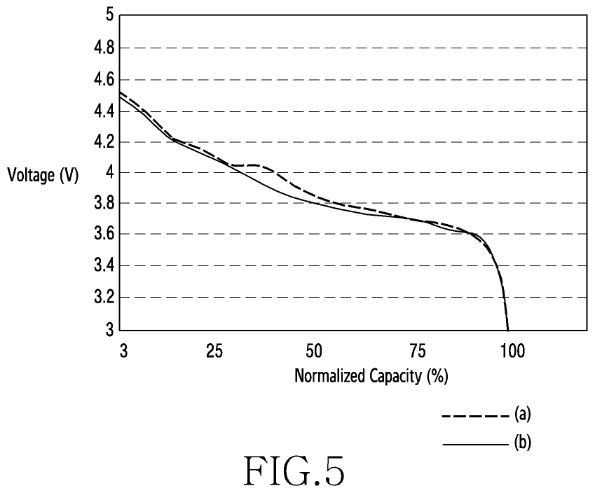

FIG. 5 is a graph showing discharge profiles of a second cathode active material and a first cathode active material according to an embodiment of the disclosure.

In an embodiment, the second cathode active material 200 may be higher in operating voltage and energy (capacity) than the first cathode active material 100, which does not include LMP 230.

Referring to FIG. 5, with reference to the discharge profile (a) of the second cathode active material 200 and the discharge profile (b) of the first cathode active material 100, the second cathode active material 200 which includes LMP 230 may make the battery higher in operating voltage and available capacity than the first cathode active material 100 which does not include LMP 230.

In an embodiment, because lithium iron phosphate works at about 3.4 V, an increase of the relative content of iron (Fe) in LMP 230 may allow the battery to improve in stability and output properties, but may decrease the energy density per volume or weight in the battery.

In an embodiment, because lithium manganese phosphate works at about 4.1 V, an increase of the relative content of manganese (Mn) in LMP 230 may allow the battery to improve in stability and output properties and may reduce a loss of energy density per volume or weight.

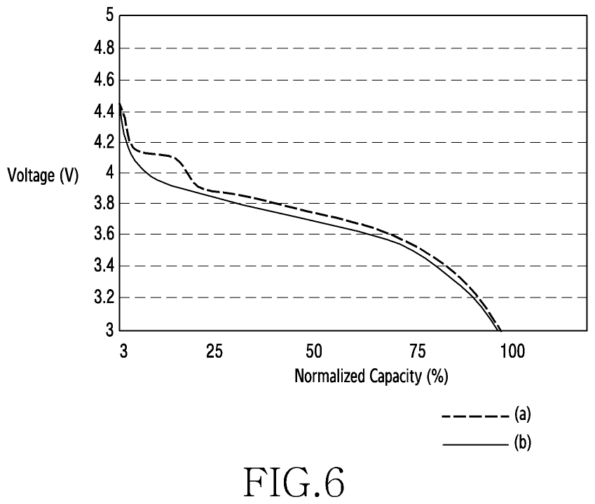

FIG. 6 is a graph showing discharge profiles of a second cathode active material and a first cathode active material in a battery having a degraded lifetime according to an embodiment of the disclosure.

Referring to FIG. 6, the second cathode active material 200 including the LMP 230 may enhance the lifetime properties of the battery. For example, referring to the discharge profile (a) of the second cathode active material 200 and the discharge profile (b) of the first cathode active material 100, the second cathode active material 200 which includes the LMP 230 may be higher in the operating voltage and available capacity of the battery than the first cathode active material 100 which does not include the LMP 230 although the battery has a degraded lifetime.

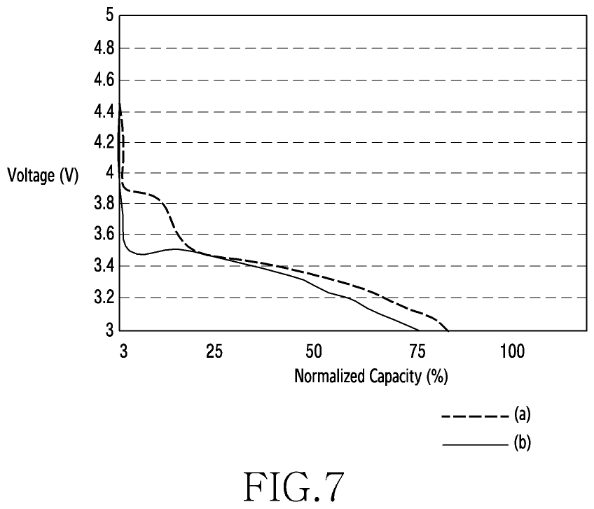

FIG. 7 is a graph showing discharge profiles of a second cathode active material and a first cathode active material in a low-temperature condition according to an embodiment of the disclosure.

Referring to FIG. 7, the second cathode active material 200 including LMP 230 may further improve the performance of the battery in low-temperature conditions than the first cathode active material 100.

In an embodiment, the lithium ion battery may operate according to the principle in which lithium ions move and diffuse. The movement of lithium ions may be affected by external environments or internal temperatures of the battery. For example, the diffusion of lithium ions may become poorer or slower at lower temperatures. A lithium ion battery may decrease in operating voltage with the decrease of the external or internal temperature.

In an embodiment, the second cathode active material 200 including the LMP 230 may exhibit an enhanced operating voltage even in the environment of low temperatures. For example, referring to the discharge profile (a) of the second cathode active material 200 and the discharge profile (b) of the first cathode active material 100 in FIG. 7, the second cathode active material 200 which includes LMP 230 may be higher than the first cathode active material 100 which does not include LMP 230 in terms of operating voltage and available capacity of battery even in a low-temperature environment (e.g., about −20° C. to −10° C.).

FIG. 8 is a graph showing volume ratios by size of particles contained in a second cathode active material according to an embodiment of the disclosure.

Referring to FIG. 8, particles contained in the second cathode active material 200 (or the second cathode active material 200) may have a particle size distribution in a tri-modal pattern.

For example, the first LCO 210 may have a first size. The first LCO 210 may range in particle size from 10 μm to 50 μm. The first LCO 210 may be present in an amount of 71% to 79% by volume.

For example, the second LCO 220 may have a second size smaller than the first size. The second LCO 220 may range in particle size from 1 μm to 10 μm. The second LCO 220 may be present in an amount of 15% to 23% by volume. According to an embodiment, the second LCO 220 may fill the interstitial volume or cavities formed by the first LCO 210. In an embodiment, the second cathode active material 200 may increase in energy density as the second LCO 220 is arranged between the first LCO 210.

For example, the LMP 230 may have a third size smaller than the second size. The LMP 230 may range in particle size from 50 nm to 200 nm. In an embodiment, the LMP 230 may be in a fine particle form. The LMP 230 may be in an amount of 3% to 9% by volume.

According to an embodiment, the LMP 230 may fill the interstitial volume or cavities formed by the first LCO 210 and the second LCO 220. The LMP 230 may be in contact with the first LCO 210 and/or the second LCO 220.

In an embodiment, the second cathode active material 200 may contain the first LCO 210, the second LCO 220, and the LMP 230 at a mass ratio of 72-80:15-24:1-6. The mass and mass ratio of LMP 230 in the second cathode active material 200 may vary depending on the composition of chemical formula 1.

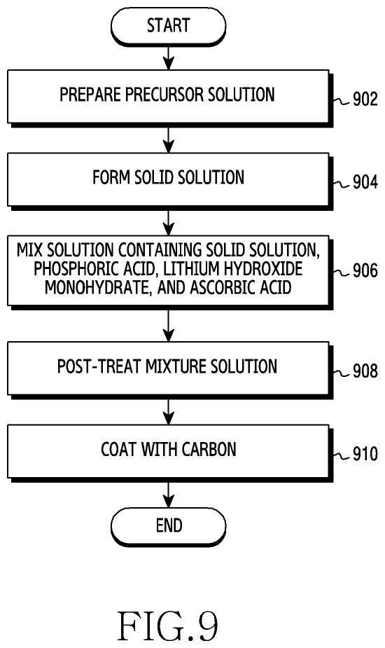

FIG. 9 is a flowchart showing a method for manufacturing an LMP having an olivine structure according to an embodiment of the disclosure.

Referring to FIG. 9, a precursor solution may be prepared in operation 902. For example, an aggregation solution of LMP 230 may be synthesized by a solvothermal synthesis method using water (H₂O) and N, N-dimethylformamide (DMF) as solvents. First, molar ratios of Co(CH₃COO)₂.4H₂O, Mn(CH₃COO)₂.4H₂O, and Fe(NO₃)₃.9H₂O may be adjusted according to a desired composition. A total of 0.01 mol of the mole-adjusted mixture of Co(CH₃COO)₂.4H₂O, Mn(CH₃COO)₂.4H₂O, and Fe(NO₃)₃.9H₂O may be dissolved in 10 ml of deionized water. The solution of Co(CH₃COO)₂.4H₂O, Mn(CH₃COO)₂.4H₂O, and Fe(NO₃)₃.9H₂O in deionized water may be mixed with 140 ml of DMF at 80° C. to give a precursor solution.

In operation 904, a solid solution may be formed in the precursor solution. For example, the aqueous precursor solution may be stirred at 80° C. for 1 hour and then cooled to room temperature to form a solid solution of Co, Mn, and Fe.

In operation 906, the solution having the solid solution formed therein may be mixed with phosphoric acid, lithium hydroxide monohydrate, and ascorbic acid. For example, predetermined amounts of phosphoric acid (H₃PO₄), lithium hydroxide monohydrate (LiOH.H₂O), and ascorbic acid (C₆H₈O₆) may be introduced into the precursor solution and then stirred. In an embodiment, the mixture solution may have a molar ratio of Li:transition metal™:PO₄=3:1:1.3.

In an embodiment, since the final particle morphology of LMP 230 depends on pH values in the aforementioned solvothermal synthesis process, pH adjustment may be made by adding a predetermined amount of nitric acid (HNO₃).

In operation 908, the mixture solution may be subjected to a post-treatment process. After being stirred, for example, the mixture solution may be transferred to an autoclave made of Teflon and heated at 180° C. for 12 hours. The thermally treated mixture solution may be centrifuged, washed with deionized and acetone, and then dried at 60° C. for 24 hours or longer. The aggregation powder of LMP 230 thus obtained is coated with a source by sufficiently mixing LMP 230 and the source (e.g., nanoparticles or a carbon source as a coating material) at a ratio of 7:3 and dried, followed by sintering at 700° C. for about 3 hours in an Ar atmosphere.

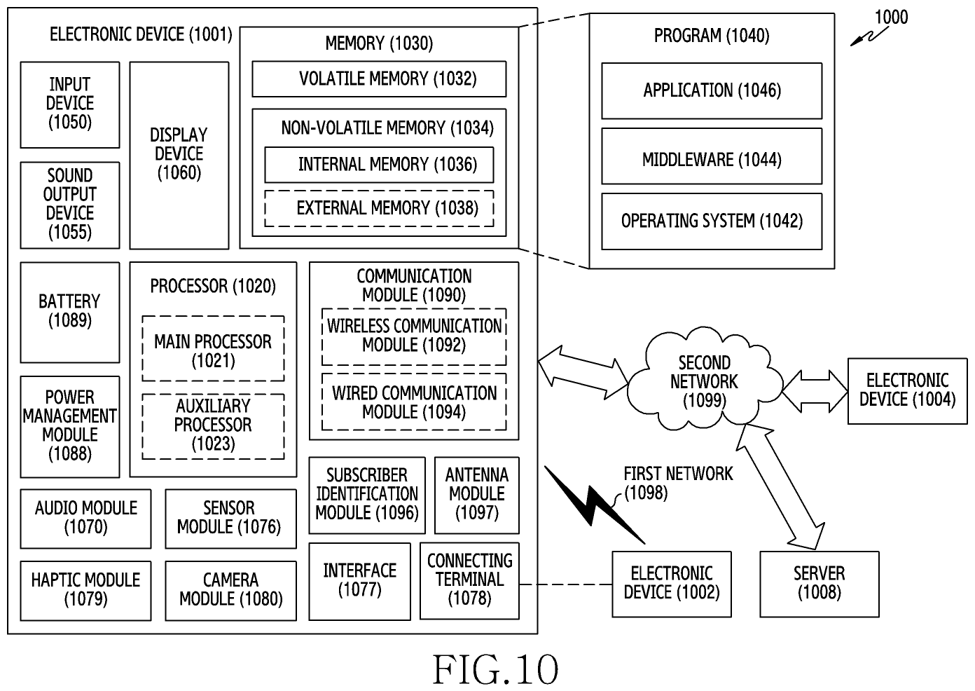

FIG. 10 is a block diagram illustrating an electronic device in a network environment according to an embodiment of the disclosure.

Referring to FIG. 10, an electronic device 1001 in a network environment 1000 may communicate with an electronic device 1002 via a first network 1098 (e.g., a short-range wireless communication network), or an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input device 1050, a sound output device 1055, a display device 1060, an audio module 1070, a sensor module 1076, an interface 1077, a haptic module 1079, a camera module 1080, a power management module 1088, a battery 1089, a communication module 1090, a subscriber identification module (SIM) 1096, or an antenna module 1097. In some embodiments, at least one (e.g., the display device 1060 or the camera module 1080) of the components may be omitted from the electronic device 1001, or one or more other components may be added in the electronic device 1001. In some embodiments, some of the components may be implemented as single integrated circuitry. For example, the sensor module 1076 (e.g., a fingerprint sensor, an iris sensor, or an illuminance sensor) may be implemented as embedded in the display device 1060 (e.g., a display).

The processor 1020 may execute, for example, software (e.g., a program 1040) to control at least one other component (e.g., a hardware or software component) of the electronic device 1001 coupled with the processor 1020, and may perform various data processing or computation. According to one embodiment, as at least part of the data processing or computation, the processor 1020 may load a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), and an auxiliary processor 1023 (e.g., a graphics processing unit (GPU), an image signal processor (ISP), a sensor hub processor, or a communication processor (CP)) that is operable independently from, or in conjunction with, the main processor 1021. Additionally or alternatively, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display device 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input device 1050 may receive a command or data to be used by other component (e.g., the processor 1020) of the electronic device 1001, from the outside (e.g., a user) of the electronic device 1001. The input device 1050 may include, for example, a microphone, a mouse, a keyboard, or a digital pen (e.g., a stylus pen).

The sound output device 1055 may output sound signals to the outside of the electronic device 1001. The sound output device 1055 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 1060 may visually provide information to the outside (e.g., a user) of the electronic device 1001. The display device 1060 may include, for example, a display, a hologram device, or a projector and control circuitry to control a corresponding one of the display, hologram device, and projector. According to an embodiment, the display device 1060 may include touch circuitry adapted to detect a touch, or sensor circuitry (e.g., a pressure sensor) adapted to measure the intensity of force incurred by the touch.

The audio module 1070 may convert a sound into an electrical signal and vice versa. According to an embodiment, the audio module 1070 may obtain the sound via the input device 1050, or output the sound via the sound output device 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to one embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™ wireless-fidelity (Wi-Fi) direct, or infrared data association (IrDA)) or the second network 1099 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., printed circuit board (PCB)). According to an embodiment, the antenna module 1097 may include a plurality of antennas. In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 and 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smailphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., an internal memory 1036 or an external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

In the lithium ion battery including a cathode, an anode, an electrolyte, and a separator interposed between the cathode and the anode according to various embodiments described above (e.g., battery 1089 in FIG. 10), the cathode includes, as active materials (e.g., second cathode active material 200 in FIG. 2), a first LiCoO₂ (LCO) (e.g., first LCO 210 in FIG. 2), a second LCO (e.g., second LCO 220 in FIG. 2), and LiCoₓMn_{y}Fe_{z}PO₄ (e.g., LMP 230 in FIG. 2) having a coating layer (e.g., coating layer 232 in FIG. 2) formed on the surface thereof, wherein the first LCO has a first size, the second LCO has a second size smaller than the first size and as such, can be located in the cavities formed by the first LCO, and the LiCoₓMn_{y}Fe_{z}PO₄ has a third size smaller than both the first size and the second size and as such, can be arranged in the cavities formed by at least one of the first LCO and the second LCO, and the LiCoₓMn_{y}Fe_{z}PO₄ has the composition ratio of x+y+z=1 (with a proviso of 0.5≤y≤1).

In an embodiment, the first size may range from 10 μm to less than 50 μm.

In an embodiment, the second size may range from 10 μm to less than 10 μm.

In an embodiment, the third size may range from 50 nm to less than 200 nm.

In an embodiment, the active materials contained in the cathode may have a particle size distribution in a tri-modal pattern.

In an embodiment, the coating layer may include carbon and may range in thickness from 0.5 nm to less than 10 nm.

In an embodiment, the first LCO may be used in an amount of 72% to less than 80% by mass with relation to the second LCO and the LiCoₓMn_{y}Fe_{z}PO₄.

In an embodiment, the second LCO may be used in an amount of 15% to less than 24% by mass with relation to the first LCO and the LiCoₓMn_{y}Fe_{z}PO₄.

In an embodiment, the LiCoₓMn_{y}Fe_{z}PO₄ may be used in an amount of 1% to less than 6% by mass with relation to the first LCO and the second LCO.

In an embodiment, the LiCoₓMn_{y}Fe_{z}PO₄ may be in contact with at least one of the first LCO and the second LCO.

In an embodiment, the first LCO and the second LCO may have a layered structure.

In an embodiment, the LiCoₓMn_{y}Fe_{z}PO₄ may have an olivine structure.

In an embodiment, the LiCoₓMn_{y}Fe_{z}PO₄ may be in fine particle form.

In an embodiment, the cathode may further include a conductive material mixed with the active material, and a current collector associated with the active material and the conductive material.

In an embodiment, the anode may further include graphite as an active material, and a current collector to which the active material of the anode is attached.

The electronic device according to various embodiments (e.g., electronic device 1001 in FIG. 10) may include a power management module (power management module 1088 in FIG. 10) and a lithium ion battery (e.g., battery 1089 in FIG. 10) configured to supply a necessary power to the electronic device by the power management module, the lithium ion battery including a cathode, an anode, an electrolyte, and a separator interposed between the cathode and the anode, wherein the cathode includes, as active materials (e.g., second cathode active material 200 in FIG. 2), a first LiCoO₂ (LCO) (e.g., first LCO 210 in FIG. 2), a second LCO (e.g., second LCO 220 in FIG. 2), and LiCoₓMn_{y}Fe_{z}PO₄ (e.g., LMP 230 in FIG. 2) having a coating layer (e.g., coating layer 232 in FIG. 2) on the surface thereof, the first LCO has a first size, the second LCO has a second size smaller than the first size such that the second LCO is arranged in the cavities formed by the first LCO, and the LiCoₓMn_{y}Fe_{z}PO₄ has a third size smaller than both the first size and the second size such that the LiCoₓMn_{y}Fe_{z}PO₄ is arranged in the cavities formed by at least one of the first LCO and the second LCO, and the LiCoₓMn_{y}Fe_{z}PO₄ has the composition ratio of x+y+z=1 (with a proviso of 0.5≤y≤1).

In an embodiment, the first size may range from 10 μm to less than 50 μm.

In an embodiment, the second size may range from 1 μm to less than 10 μm.

In an embodiment, the third size may range from 50 nm to less than 200 nm.

In an embodiment, the LiCoₓMn_{y}Fe_{z}PO₄ may have an olivine structure.

In an embodiment, the use of the carbon active material containing a mixture of large particles of LiCoO₂ (LCO), small particles of LCO, and fine particles of carbon-coated lithium metal phosphate in a tri-modal pattern can enhance output properties and energy density in the lithium ion battery and alleviate the battery degradation caused by use and guarantee the battery enhanced thermal stability even upon the formation of an internal short circuit.

Advantageous effects obtainable from the disclosure may not be limited to the above mentioned effects, and other advantageous effects which are not mentioned may be clearly understood, through the following descriptions, by those skilled in the art to which the disclosure pertains.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A lithium ion battery comprising:
a cathode;
an anode;
an electrolyte; and
a separator interposed between the cathode and the anode,
wherein the cathode comprises, as active materials, a first LiCoO₂ (LCO), a second LCO, and LiCoₓMn_{y}Fe_{z}PO₄ having a coating layer on a surface thereof,
wherein the first LCO has a first size,
wherein the second LCO has a second size smaller than the first size such that the second LCO is arranged in cavities formed by the first LCO,
wherein the LiCoₓMn_{y}Fe_{z}PO₄ has a third size smaller than both the first size and the second size such that the LiCoₓMn_{y}Fe_{z}PO₄ is arranged in cavities formed by at least one of the first LCO and the second LCO, and
wherein the LiCoₓMn_{y}Fe_{z}PO₄ has a composition ratio of x+y+z=1 (with a proviso of 0.5≤y≤1).

2. The lithium ion battery of claim 1, wherein the first size ranges from 10 μm to less than 50 μm.

3. The lithium ion battery of claim 1, wherein the second size ranges from 1 μm to less than 10 μm.

4. The lithium ion battery of claim 1, wherein the third size ranges from 50 nm to less than 200 nm.

5. The lithium ion battery of claim 1, wherein the active materials in the cathode have a particle size distribution in a tri-modal pattern.

6. The lithium ion battery of claim 1, wherein the coating layer comprises carbon and ranges in thickness from 0.5 nm to less than 10 nm.

7. The lithium ion battery of claim 1, wherein the first LCO is used in an amount of 72% to less than 80% by mass with relation to the second LCO and the LiCoₓMn_{y}Fe_{z}PO₄.

8. The lithium ion battery of claim 1, wherein the second LCO is used in an amount of 15% to less than 24% by mass with relation to the first LCO and the LiCoₓMn_{y}Fe_{z}PO₄.

9. The lithium ion battery of claim 1, wherein the LiCoₓMn_{y}Fe_{z}PO₄ is used in an amount of 1% to less than 6% by mass with relation to the first LCO and the second LCO.

10. The lithium ion battery of claim 1, wherein the LiCoₓMn_{y}Fe_{z}PO₄ is in contact with at least one of the first LCO and the second LCO.

11. The lithium ion battery of claim 1, wherein the first LCO and the second LCO have a layered structure.

12. The lithium ion battery of claim 1, wherein the LiCoₓMn_{y}Fe_{z}PO₄ has an olivine structure.

13. The lithium ion battery of claim 1, wherein the LiCoₓMn_{y}Fe_{z}PO₄ is in a fine particle form.

14. The lithium ion battery of claim 1, wherein the cathode further comprises:
a conductive material mixed with the active material, and
a current collector associated with the active material and the conductive material.

15. The lithium ion battery of claim 1, wherein the anode further comprises:
graphite as an active material; and
a current collector to which the active material of the anode is attached.

16. An electronic device comprising:
a power management module; and
a lithium ion battery configured to supply a necessary power to the electronic device by the power management module, the lithium ion battery comprising:
a cathode,
an anode,
an electrolyte, and
a separator interposed between the cathode and the anode,
wherein the cathode comprises, as active materials, a first LiCoO₂ (LCO), a second LCO, and LiCoₓMn_{y}Fe_{z}PO₄ having a coating layer on a surface thereof,
wherein the first LCO has a first size,
wherein the second LCO has a second size smaller than the first size such that the second LCO is arranged in cavities formed by the first LCO,
wherein the LiCoₓMn_{y}Fe_{z}PO₄ has a third size smaller than both the first size and the second size such that the LiCoₓMn_{y}Fe_{z}PO₄ is arranged in cavities formed by at least one of the first LCO and the second LCO, and
wherein the LiCoₓMn_{y}Fe_{z}PO₄ has a composition ratio of x+y+z=1 (with a proviso of 0.5≤y≤1).

17. The electronic device of claim 16, wherein the first size ranges from 10 μm to less than 50 μm.

18. The electronic device of claim 16, wherein the second size ranges from 1 μm to less than 10 μm.

19. The electronic device of claim 16, wherein the third size ranges from 50 nm to less than 200 nm.

20. The electronic device of claim 16, wherein the LiCoₓMn_{y}Fe_{z}PO₄ has an olivine structure.

21. The electronic device of claim 16, wherein as Fe increases in a relative content (z), a reaction rate of lithium ions increases to improve an output property of the lithium ion battery and a reduction in an operating voltage and a capacity of the lithium ion battery.

22. The electronic device of claim 21, wherein the lithium ion battery increases in the operating voltage and the capacity with an increase of Mn in a relative content (y).
